(19) United States
(12) Patent Application Publication
(10) Pub. No.: US 2024/0370948 A1
(43) Pub. Date: Nov. 7, 2024

(54) METHOD FOR OBSERVING PER UNIT YIELD OF WHEAT BASED ON COMPUTER VISION AND DEEP LEARNING TECHNOLOGY

(71) Applicant: AEROSPACE INFORMATION RESEARCH INSTITUTE, CHINESE ACADEMY OF SCIENCES, Beijing (CN)

(72) Inventors: Bingfang WU, Beijing (CN); Fangming WU, Beijing (CN); Hongwei ZENG, Beijing (CN); Miao ZHANG, Beijing (CN)

(21) Appl. No.: 18/704,679

(22) PCT Filed: Oct. 25, 2022
(86) PCT No.: PCT/CN2022/127203

§ 371 Date: Apr. 25, 2024

(30) Foreign Application Priority Data
Oct. 26, 2021 (CN) 202111263412.0

(51) Int. Cl. G06Q 50/02; G06N 3/084

(52) U.S. Cl. CPC G06Q 50/02; G06N 3/084

(57) ABSTRACT

A method for observing a per unit yield of wheat based on computer vision and deep learning technology, including: acquiring wheat spike images and coordinate position data; calculating a camera parameter, and performing a distortion correction and a cropping on the images; performing a wheat spike recognition on the wheat spike image by using a deep learning target recognition model; performing a wheat spike recognition on the wheat spike image by using a trained deep learning target recognition model 1 and cropping a wheat spike from the wheat spike image; performing a wheat grain recognition on the wheat spike image by using a trained deep neural network target recognition model 2; calculating a number of spikes per unit area in a same wheat field by using a corrected wheat spike image and a recognized wheat spike; calculating a number of effective grains of spikes in same wheat field by using the corrected wheat spike image and a recognized wheat grain; predicting thousand-grain weight according to the number of spikes per unit area, climate condition and deep neural network model of thousand-grain weight; and calculating per mu yield according to predicted thousand-grain weight and the number of effective grains of spikes per unit area.

### CROSS REFERENCE TO RELATED APPLICATION

This application is a Section 371 National Stage Application of International Application No. PCT/CN2022/127203, filed on Oct. 25, 2022, entitled “METHOD FOR OBSERVING PER UNIT YIELD OF WHEAT BASED ON COMPUTER VISION AND DEEP LEARNING TECHNOLOGY”, which claims priority to Chinese Application No. 202111263412.0 filed on Oct. 26, 2021, the entire content of which is incorporated herein by reference in its entirety.

### TECHNICAL FIELD

The present disclosure belongs to the field of deep learning technology, and relates to a method for observing a per unit yield of wheat based on computer vision and deep learning technology.

### BACKGROUND

A per unit yield of wheat refers to a wheat yield per unit area. A prediction of the per unit yield may provide a reference for agricultural management decision-making, help prepare packaging and transportation resources required for wheat harvesting, storage and sales in advance, and help adjust macro policies for timely and effective response to food shortages and supply shocks.

A current standard method for measuring a per unit yield of wheat is to detect a number of effective spikes per mu and a number of effective grains of spikes per mu. It is possible to take samples using a sampling box having a known area in a fixed monitoring region, count the number of spikes, remove spikelets having less than five grains, and calculate the number of effective spikes per mu. Then, it is possible to randomly pick twenty wheat spikes from roots in the fixed monitoring region, remove wheat spikes having less than five grains, then count the number of grains, and calculate an average number of grains per spike. A yield may be predicted according to a normal thousand-grain weight (approved thousand-grain weight) of the monitored variety. The number of effective spikes per mu and the number of effective grains of spikes per mu are both obtained by a manual counting method, which is time-consuming and laborious, and a subjective factor may affect a counting accuracy.

The patent with publication number CN103632157B discloses a method for counting a number of grains in a wheat spike by using a digital image processing technology. It is possible to obtain wheat spike characteristics such as a spike axis length and a spike area by the digital image processing technology, and calculate the number of grains in the wheat spike according to an established relationship between the number of grains in the wheat spike and the wheat spike characteristics such as the spike axis length and the spike area. However, on the one hand, this method may cause a measurement error due to an influence of an image distortion when obtaining the wheat spike characteristics such as the spike axis length and the spike area. On the other hand, the relationship between the number of grains in the wheat spike and the wheat spike characteristics such as the spike axis length and the spike area established by this method may also cause a counting error due to an influence of variety. Moreover, a wheat spike image acquisition device using this method includes a CCD camera, a stage, a computer, etc., an image acquisition is performed indoors, and only one wheat spike image may be taken at a time, which may not be applied to a rapid acquisition of field environmental image data.

### SUMMARY

The present disclosure may be achieved through the following technical solutions.

A method for observing a per unit yield of wheat based on computer vision and deep learning technology, including:
acquiring wheat spike images and coordinate position data in a vertical downward direction and a horizontal direction at different positions in a same wheat field;
calculating a camera parameter according to a wheat spike image containing a checker board, and performing a distortion correction and a cropping on the wheat spike images;
performing a wheat spike recognition on the wheat spike image by using a deep learning target recognition model; performing a wheat spike recognition on the wheat spike image by using a trained deep learning target recognition model 1 and cropping a wheat spike from the wheat spike image; performing a wheat grain recognition on the wheat spike image by using a trained deep neural network target recognition model 2;
calculating a number of spikes per unit area in a same wheat field by using a corrected wheat spike image and a recognized wheat spike; calculating a number of effective grains of spikes in a same wheat field by using the corrected wheat spike image and a recognized wheat grain;
predicting a thousand-grain weight according to the number of spikes per unit area, a climate condition and a deep neural network model of the thousand-grain weight; and calculating a per mu yield according to a predicted thousand-grain weight and the number of effective grains per unit area.

### BRIEF DESCRIPTION OF THE DRAWINGS

FIG. 1 shows a flowchart of a method for observing a per unit yield of wheat based on computer vision and deep learning technology of the present disclosure;

FIG. 2 shows a structural diagram of a method for observing a per unit yield of wheat based on computer vision and deep learning technology of the present disclosure.

### DETAILED DESCRIPTION OF EMBODIMENTS

The present disclosure provides a method for observing a per unit yield of wheat based on computer vision and deep learning technology, which may quickly identify a number of effective spikes per unit area and a number of effective grains of spikes per unit area, predict a thousand-grain weight of wheat in case of different numbers of spikes per unit area and climatic conditions, and improve an efficiency and accuracy of yield observation.

The present disclosure will be described in detail below with reference to the accompanying drawings.

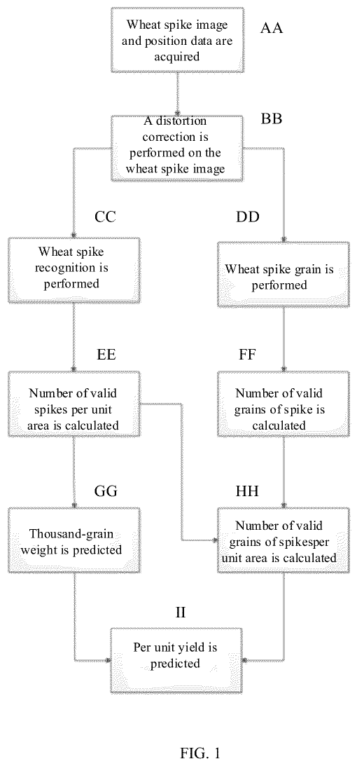

As shown in FIG. 1, a method for observing a per unit yield of wheat based on computer vision and deep learning technology in an embodiment specifically includes the following steps.

In step 1, wheat spike images and coordinate position data are acquired using cameras in a vertical downward direction and a horizontal direction at different positions in a same wheat field.

In such embodiments, the wheat spike image is acquired by the following steps.
In step 1.1, a camera A is fixed at a predetermined height above the wheat so that a lens faces vertically downward. In a specific implementation, the predetermined height is generally 1.5 meters.
In step 1.2, a checker board is horizontally placed above the wheat, and an image 1 is taken; then the checker board is removed, and an image 2 is taken at the same position.
In step 1.3, a camera B is fixed on a side of the wheat at the same height as wheat spikes, so that a lens faces the wheat spikes horizontally.
In step 1.4, the checker board is placed behind the wheat spikes, and an image 3 is taken.
In step 1.5, the camera A and the camera B are rotated clockwise to take the image 2 and the image 3 respectively. In a specific implementation, the clockwise rotation may be performed every 60 degrees.
In step 1.6, the above steps are repeatedly performed to take at least ten sets of images at different positions in the same wheat field.

In a specific implementation, the coordinate position data may be acquired simultaneously with the wheat spike images, and the coordinate position data may be written into an attribute of image data.
In step 2, camera parameters are calculated according to the wheat spike images containing the checker board, and a distortion correction and a cropping are performed on the images. The specific steps are as follows.
In step 2.1, the wheat spike image containing the checker board is processed to obtain an intrinsic parameter of the camera and a distortion coefficient of the camera. In such embodiments, the wheat spike image containing the checker board is processed using a calibration method of Zhang Zhengyou.
In step 2.2, a distortion correction is performed on the wheat spike image according to the intrinsic parameter of the camera and the distortion coefficient of the camera.
In step 2.3, a corrected wheat spike image is cropped using a minimum internal tangent method.
In step 3, a wheat spike recognition is performed on the wheat spike image by using a deep learning target recognition model. The specific steps are as follows.
In step 3.1, the wheat spike image is cut into blocks, and the image blocks are labeled.
In step 3.2, the labeled image blocks of the wheat spike image are divided into a training set and a validation set in ratio. In a specific implementation, the training set and the validation set may be divided in a ratio of 8:2;
In step 3.3, the deep learning target recognition model is iteratively trained using the training set according to a gradient descent optimization algorithm to continuously fit and optimize parameters of the model.
In step 3.4, a wheat spike recognition is performed on the image blocks by using the trained deep learning model.
In step 3.5, results of the recognition on the image blocks at the same position are stitched to have a size of the corrected image. In a specific implementation, during the stitching process, overlapping observation regions are processed using a non-maximum suppression method, and only a highest-scoring box of each wheat spike is retained.
In step 4, a wheat spike recognition is performed on the wheat spike image by using a trained deep learning target recognition model 1, and the wheat spikes are cropped. A wheat grain recognition is performed on the wheat spike image by using a trained deep neural network target recognition model 2. Training data of the deep learning target recognition model 1 includes a position of the wheat spikes in the image 3, and training data of the deep learning target recognition model 2 includes a position of the wheat grains in the cropped image 3.
In step 5, a number of spikes per unit area in the same wheat field is calculated using the corrected wheat spike image and the identified wheat spikes. The specific steps are as follows.
In step 5.1, corner points of the checker board in the corrected image 1 are detected, and a number of pixels between the corner points is calculated.
In step 5.2, an actual horizontal distance and an actual vertical distance between the corner points are divided by the number of pixels between the corner points to calculate a horizontal distance dx of a single pixel and a vertical distance dy of a single pixel.
In step 5.3, a number of pixels in the horizontal direction and a number of pixels in the vertical direction in the corrected image 2 are counted and respectively multiplied by the horizontal distance dx of a single pixel and the vertical distance dy of a single pixel obtained in step 5.2, so as to obtain a horizontal distance x and a vertical distance y.
In step 5.4, a number of spikes M identified in step 3 in the same wheat field is counted, and then a number of spikes per unit area W=M/Σ(x×y) is obtained.
In step 6, a number of effective grains of spikes in the same wheat field is calculated according to the corrected wheat spike image and the identified wheat grains. The specific steps are as follows.
In step 6.1, corner points of the checker board in the corrected image 3 are detected, and a number of pixels between the corner points is calculated.
In step 6.2, an actual horizontal distance and an actual vertical distance between the corner points are divided by the number of pixels between the corner points to calculate a horizontal distance dx′ of a single pixel and a vertical distance dy′ of a single pixel.
In step 6.3, a number of pixels in the horizontal direction and a number of pixels in the vertical direction of a wheat grain in the corrected image 3 are counted and respectively multiplied by the horizontal distance dx′ of a single pixel and the vertical distance dy′ of a single pixel obtained in step 6.2, so as to obtain a horizontal distance x′ and a vertical distance y′.
In step 6.4, a number of spikes M′ and a number of wheat grains N identified in step 4 in the same wheat field are counted.
In step 6.5, a cluster analysis is performed on the horizontal distance x′ and the vertical distance y′ of wheat grains obtained in the same wheat field using the method in step 6.3, a small cluster far away from other clusters is discarded to obtain the number of effective wheat grains N′, and then a number of effective grains of spikes per unit area G=W×2N′/M′ is obtained.
In step 7, a thousand-grain weight is predicted according to a number of spikes per unit area, a climate condition and a deep neural network model of a thousand-grain weight. The specific steps are as follows.
In step 7.1, the number of spikes per unit area, the climatic condition and historical data of thousand-grain weight are used as a training set. In a specific implementation, the climatic condition generally includes a minimum temperature, a maximum temperature, an average temperature, a rainfall, sunshine hours, etc.
In step 7.2, neurons, an initial value ω of a network parameter, a learning rate η and a loss function Loss of the deep neural network model are set. The model includes a hidden layer between an input layer and an output layer.
In step 7.3, a training sample Xᵢ is randomly selected from the training set, and is forward propagated under the current network parameter ω to obtain a loss value loss.
In step 7.4, a back propagation is performed according to the chain rule to calculate a gradient value δLoss/δw, and the network parameter is updated to

$$ω <= ω - η \cdot \frac{δ Loss}{δω}$$

according to the gradient value.
In step 7.5, steps 7.3 and 7.4 are repeatedly performed until the loss value loss meets a target or a number of iterations is reached, then the network training is completed.
In step 7.6, the thousand-grain weight is predicted using the trained deep neural network, the current number of spikes per unit area and the climatic condition.
In step 8, a per mu yield is calculated according to the predicted thousand-grain weight and the number of effective grains per unit area. The specific steps are as follows.
In step 8.1, a yield per unit area=the number of effective grains per unit area×the predicted thousand-grain weight is calculated.
In step 8.2, an average yield per square meter of ten sample points is multiplied by 666.7 to calculate the per mu yield.

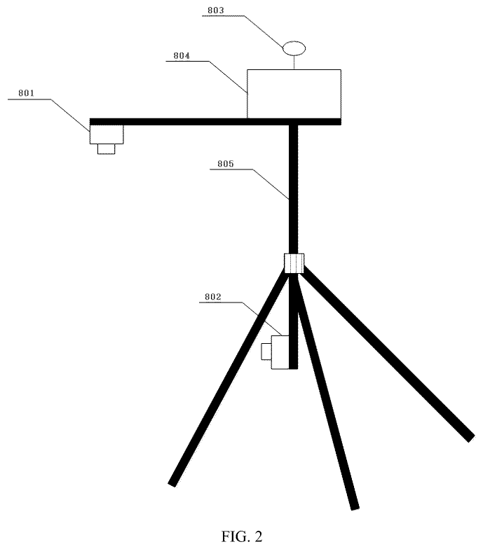

As shown in FIG. 2, a method for observing a per unit yield of wheat based on computer vision and deep learning technology in an embodiment specifically includes: a camera 801 used to acquire a top-view wheat image in a vertical downward direction in a target region; a camera 802 used to acquire a side-view wheat image in a horizontal direction in the target region; a positioning information receiving unit 803 used to acquire a position information of a sample point in the target region; a data processing unit 804 used to process the acquired images and position information, identify a number of spikes per unit area and a number of effective grains, predict a thousand-grain weight through a deep neural network for a number of spikes per unit area, a climate condition and a thousand-grain weight, and calculate a per unit yield of wheat in the target region; and a bracket 805 used to fix the cameras and the data processing unit, where a height of the bracket 805 is adjustable to ensure a coverage of the top-view wheat image and the side-view wheat image, and a central axis of the bracket is 360 degrees rotatable.

The present disclosure has the following beneficial effects.

The present disclosure may quickly and directly identify the number of effective spikes per unit area and the number of effective grains of spikes per unit area by using a deep neural network target recognition method instead of the manual counting. An accurate number of spikes per unit area and an accurate number of effective wheat grains may be obtained through the distortion correction of the camera. The thousand-grain weight is predicted by the deep neural network established for the number of spikes per unit area, the climatic condition and the thousand-grain weight, which may improve the efficiency and accuracy of the per unit yield observation.

In summary, the above are just preferred embodiments of the present disclosure and are not intended to limit the protection scope of the present disclosure. Any modifications, equivalent substitutions, improvements, etc. made within the spirit and principles of the present disclosure should be included in the protection scope of the present disclosure.

1. A method for observing a per unit yield of wheat based on computer vision and deep learning technology, comprising:
acquiring wheat spike images and coordinate position data in a vertical downward direction and a horizontal direction at different positions in a same wheat field; calculating a camera parameter according to a wheat spike image containing a checker board, and performing a distortion correction and a cropping on the wheat spike images;
performing a wheat spike recognition on the wheat spike image by using a deep learning target recognition model; performing a wheat spike recognition on the wheat spike image by using a trained deep learning target recognition model 1 and cropping a wheat spike from the wheat spike image; performing a wheat grain recognition on the wheat spike image by using a trained deep neural network target recognition model 2;
calculating a number of spikes per unit area in a same wheat field by using a corrected wheat spike image and a recognized wheat spike; calculating a number of effective grains of spikes in a same wheat field by using the corrected wheat spike image and a recognized wheat grain;
predicting a thousand-grain weight according to the number of spikes per unit area, a climate condition and a deep neural network model of the thousand-grain weight; and calculating a per mu yield according to a predicted thousand-grain weight and the number of effective grains of spikes per unit area.

2. The method according to claim 1, wherein the wheat spike image is acquired by:
step 1.1 of fixing a camera A at a predetermined height above a wheat so that a lens faces vertically downward;
step 1.2 of placing the checker board horizontally above the wheat and taking an image 1; removing the checker board and taking an image 2 at the same position;
step 1.3 of fixing a camera B on a side of the wheat at the same height as the wheat spikes so that a lens faces the wheat spikes horizontally;
step 1.4 of placing the checker board behind the wheat spikes and taking an image 3;
step 1.5 of rotating the camera A and the camera B clockwise to take the image 2 and the image 3 respectively; and
step 1.6 of repeatedly performing the above steps to take at least ten sets of images at different positions in the same wheat field.

3. The method according to claim 2, wherein the predetermined height in step 1.1 is 1.5 meters.

4. The method according to claim 2, wherein a clockwise rotation in step 1.5 is performed every 60 degrees.

5. The method according to claim 2, wherein the coordinate position data is acquired simultaneously with the wheat spike image, and the coordinate position data is written into an attribute of image data.

6. The method according to claim 1, wherein the calculating a camera parameter according to a wheat spike image containing a checker board and performing a distortion correction and a cropping on the wheat spike images comprises:
step 2.1 of processing the wheat spike image containing the checker board to obtain an intrinsic parameter of the camera and a distortion coefficient of the camera;
step 2.2 of performing a distortion correction on the wheat spike image by using the intrinsic parameter of the camera and the distortion coefficient of the camera; and
step 2.3 of cropping a corrected wheat spike image according to a minimum internal tangent method.

7. The method according to claim 6, wherein the wheat spike image containing the checker board is processed using a calibration method of Zhang Zhengyou.

8. The method according to claim 1, wherein the performing a wheat spike recognition on the wheat spike image by using a deep learning target recognition model comprises:
step 3.1 of cutting the wheat spike image into blocks, and labeling the image blocks;
step 3.2 of dividing the labeled image blocks into a training set and a validation set in ratio;
step 3.3 of iteratively training the deep learning target recognition model using the training set according to a gradient descent optimization algorithm to continuously fit and optimize a parameter of the model;
step 3.4 of performing a wheat spike recognition on the image blocks by using a trained deep learning model; and
step 3.5 of stitching results of the recognition of the image blocks at the same position to have a size of the corrected image.

9. The method according to claim 8, wherein in step 3.2, the training set and the validation set are divided in a ratio of 8:2.

10. The method according to claim 8, wherein in a stitching process in step 3.5, overlapping observation regions are processed using a non-maximum suppression method, and only a highest-scoring box for each wheat spike is retained.

11. The method according to claim 1, wherein the calculating a number of spikes per unit area in a same wheat field by using a corrected wheat spike image and a recognized wheat spike comprises:
step 5.1 of detecting corner points of the checker board in a corrected image 1, and calculating a number of pixels between the corner points;
step 5.2 of dividing an actual horizontal distance and an actual vertical distance between the corner points by the number of pixels between the corner points to calculate a horizontal distance dx of a single pixel and a vertical distance dy of a single pixel;
step 5.3 of counting a number of pixels in the horizontal direction and a number of pixels in the vertical direction in the corrected image 2, and multiplying the number of pixels in the horizontal direction and the number of pixels in the vertical direction in the corrected image 2 respectively by the horizontal distance dx of the single pixel and the vertical distance dy of the single pixel calculated in step 5.2, so as to obtain a horizontal distance x and a vertical distance y; and
step 5.4 of counting a number of spikes M identified in step 3 in the same wheat field, and calculating the number of spikes per unit area W=M/Σ(x×y).

12. The method according to claim 1, wherein the calculating a number of effective grains of spikes in a same wheat field by using the corrected wheat spike image and a recognized wheat grain comprises:
step 6.1 of detecting corner points of the checker board in a corrected image 3, and calculating a number of pixels between the corner points;
step 6.2 of dividing an actual horizontal distance and an actual vertical distance between the corner points by the number of pixels between the corner points to calculate a horizontal distance dx′ of a single pixel and a vertical distance dy′ of a single pixel;
step 6.3 of counting a number of pixels in the horizontal direction and a number of pixels in the vertical direction of a wheat grain in the corrected image 3, and multiplying the number of pixels in the horizontal direction and the number of pixels in the vertical direction of the wheat grain in the corrected image 3 respectively by the horizontal distance dx′ of the single pixel and the vertical distance dy′ of the single pixel calculated in step 6.2, so as to obtain a horizontal distance x′ and a vertical distance y′;
step 6.4 of counting a number of spikes M′ and a number of wheat grains N identified in step 4 in the same wheat field; and
step 6.5 of performing a cluster analysis on the horizontal distance x′ and the vertical distance y′ of wheat grains obtained in step 6.3 in the same wheat field, discarding a small cluster far away from other clusters to obtain a number of effective wheat grains N′, and calculating a number of effective grains of spikes per unit area G=W×2N′/M′.

13. The method according to claim 1, wherein the predicting a thousand-grain weight according to the number of spikes per unit area, a climate condition and a deep neural network model for the thousand-grain weight comprises:
step 7.1 of using the number of spikes per unit area, the climate condition and historical data of the thousand-grain weight as a training set;
step 7.2 of setting neurons, an initial value ω of a network parameter, a learning rate η and a loss function Loss of the deep neural network model;
step 7.3 of randomly selecting a training sample X; from the training set, and forward propagating Xᵢ under a current network parameter w to obtain a loss value loss;
step 7.4 of performing a back propagation according to the chain rule to obtain a gradient value δLoss/δw, and updating the network parameter according to the gradient value;
step 7.5 of repeatedly performing step 7.3 and step 7.4 until the loss value loss meets a target or a number of iterations is reached, so as to complete a network training; and
step 7.6 of predicting the thousand-grain weight by using the trained deep neural network, the number of spikes per unit area of the current wheat field, and the climatic condition.

14. The method according to claim 13, wherein the climate condition comprises a minimum temperature, a maximum temperature, an average temperature, a rainfall, and sunshine hours.

15. The method according to claim 13, wherein the model comprises a hidden layer between an input layer and an output layer.

16. The method according to claim 13, wherein the network parameter is updated according to the gradient value by using:
$$ω <= ω - η \cdot \frac{δ Loss}{δω}$$

17. The method according to claim 13, wherein the calculating a per mu yield according to a predicted thousand-grain weight and the number of effective grains of spikes per unit area comprises:
step 8.1 of calculating a yield per unit area=the number of effective grains of spikes per unit area×the predicted thousand-grain weight; and
step 8.2 of multiplying an average yield per square meter of ten sample points by 666.7 to calculate the per mu yield.

18. A device for observing a per unit yield of wheat based on computer vision and deep learning technology, comprising:
a camera 801 configured to acquire a top-view wheat image in a vertical downward direction in a target region;
a camera 802 configured to acquire a side-view wheat image in a horizontal direction in the target region;
a positioning information receiving unit 803 configured to acquire a position information of a sample point in the target region;
a data processing unit 804 configured to process the acquired images and position information, identify a number of spikes per unit area and a number of effective grains of spikes, predict a thousand-grain weight according to a deep neural network established for the number of spikes per unit area, a climate condition and a thousand-grain weight, and calculate the per unit yield of wheat in the target region; and
a bracket 805 configured to fix the cameras and the data processing unit, wherein a height of the bracket 805 is adjustable to ensure a coverage of the top-view wheat image and the side-view wheat image, and a central axis of the bracket is 360 degrees rotatable.
